(19) United States
(12) Patent Application Publication
(10) Pub. No.: US 2024/0242050 A1
(43) Pub. Date: Jul. 18, 2024

(54) TRANSACTION CARD WITH MAGNETIC STRIPE SEGMENTS

(71) Applicant: Capital One Services, LLC, McLean, VA (US)

(72) Inventors: Bryant YEE, Silver Spring, MD (US); Tyler MAIMAN, Melville, NY (US); Cruz VARGAS, Ocean Springs, MS (US)

(21) Appl. No.: 18/154,611

(22) Filed: Jan. 13, 2023

(51) Int. Cl. G06K 19/06; G06Q 20/34

(52) U.S. Cl. CPC G06K 19/06196; G06Q 20/341

(57) ABSTRACT

In some implementations, a transaction card may include a card body and a plurality of magnetic stripe segments disposed on the card body. The plurality of magnetic stripe segments may be non-contiguous with each other. The plurality of magnetic stripe segments may define a tactile pattern that indicates an attribute of the transaction card.

### BACKGROUND

Transactions often involve use of a transaction card (e.g., a credit card, a debit card, a gift card, an automated teller machine (ATM) card, a rewards card, an access card, or client loyalty card, among other examples) to pay for products or services at a transaction terminal (e.g., a point of sale (PoS) terminal) of an individual or business engaged in the sale of goods or services (e.g., via a swiping of the transaction card at a card reader, insertion of the transaction card into a chip reader, or wireless transmission of transaction card data to a wireless receiver). In some instances, a magnetic stripe, an integrated circuit chip, a radio frequency (RF) antenna, and/or a radio frequency identification (RFID) tag may be included in a transaction card to provide information associated with the transaction card (e.g., an account identifier, account information, a payment token, or the like).

### SUMMARY

In some implementations, a transaction card may include a card body and a plurality of magnetic stripe segments disposed on the card body. The plurality of magnetic stripe segments may be non-contiguous with each other. The plurality of magnetic stripe segments may be arranged on the card body such that the plurality of magnetic stripe segments are readable by a magnetic stripe reader from a single swipe of the transaction card through the magnetic stripe reader. The plurality of magnetic stripe segments may define a tactile pattern that indicates an attribute of the transaction card.

In some implementations, a transaction card may include a card body and a plurality of magnetic stripe segments disposed on the card body. The plurality of magnetic stripe segments may be non-contiguous with each other. The plurality of magnetic stripe segments may define a tactile pattern that indicates an attribute of the transaction card.

In some implementations, a method may include segmenting a magnetic stripe into a plurality of magnetic stripe segments, and applying the plurality of magnetic stripe segments to a card body of a transaction card such that the plurality of magnetic stripe segments are readable by a magnetic stripe reader from a single swipe of the transaction card through the magnetic stripe reader.

### BRIEF DESCRIPTION OF THE DRAWINGS

FIGS. 1A-1B show an example transaction card, in accordance with some embodiments of the present disclosure.

FIG. 2A shows a cross-sectional view of the example transaction card of FIGS. 1A-1B taken along line Y-Y, in accordance with some embodiments of the present disclosure.

FIG. 2B shows an alternative cross-sectional view of the example transaction card of FIGS. 1A-1B taken along line Y-Y, in accordance with some embodiments of the present disclosure.

FIG. 2C shows an alternative cross-sectional view of the example transaction card of FIGS. 1A-1B taken along line Y-Y, in accordance with some embodiments of the present disclosure.

FIG. 3 shows the example transaction card of FIGS. 1A-1B with a plurality of tactile elements, in accordance with some embodiments of the present disclosure.

FIGS. 4-6 show the example transaction card of FIGS. 1A-1B with alternative configurations of the magnetic stripe segments, in accordance with some embodiments of the present disclosure.

FIG. 7 is a flowchart of an example process associated with manufacturing a transaction card with magnetic stripe segments, in accordance with some embodiments of the present disclosure.

### DETAILED DESCRIPTION

The following detailed description of example implementations refers to the accompanying drawings. The same reference numbers in different drawings may identify the same or similar elements.

As described above, a transaction card may include a magnetic stripe that can be used to provide information associated with the transaction card. For example, a magnetic stripe reader may obtain the information when the transaction card is swiped at the magnetic stripe reader. Generally, the transaction card may be configured for swiping at the magnetic stripe reader in a single orientation, and the magnetic stripe reader may be unable to obtain the information when the transaction card is swiped at the magnetic stripe reader using an improper orientation of the transaction card. Because there are multiple orientations at which the transaction card can be swiped at the magnetic stripe reader, improper orientations are commonly used. As a result, the magnetic stripe reader may expend significant computing resources (e.g., processor resources and/or memory resources), power resources, and/or network resources attempting to read the information, execute a transaction, and/or transmit transaction details when the transaction card is in an improper orientation. Moreover, an execution time of the transaction may be prolonged when one or more improper orientations of the transaction card are attempted. Similar issues may exist for tapping or inserting a transaction card with an integrated circuit (IC) chip at a chip reader.

For individuals with visual impairments and/or in low-light environments, it may be particularly difficult to identify a correct orientation of a transaction card. Moreover, numerous transaction cards may be stored in a storage article (e.g., a wallet, a billfold, a purse, or the like). Thus, for individuals with visual impairments and/or in low-light environments, it may be difficult to select a particular transaction card from multiple transaction cards.

Some implementations described herein provide a transaction card that includes a plurality of magnetic stripe segments disposed on a card body of the transaction card. For example, rather than having a unitary magnetic stripe disposed on the card body, the magnetic stripe may be divided into magnetic stripe segments that are disposed on the card body in a magnetic stripe region where the unitary magnetic stripe would otherwise be located. Thus, the magnet stripe segments may be readable by a magnetic stripe reader from a single swipe of the transaction card through the magnetic stripe reader.

The magnetic stripe segments may be arranged on the card body in a non-contiguous manner, such that gaps (e.g., void spaces) are defined between magnetic stripe segments. In this way, the magnetic stripe segments function as tactile elements (e.g., at transitions between magnetic stripe segments and gaps) on the card body. The magnetic stripe segments may be arranged on the card body to define a particular tactile pattern that indicates an attribute of the transaction card, such as a type of the transaction card (e.g., a debit card, a credit card, a rewards card, or the like) and/or an issuer of the transaction card. Thus, multiple transaction cards may have respective magnetic stripe segments defining different tactile patterns, thereby facilitating differentiation between the multiple transaction cards using the tactile patterns. Moreover, by functioning as tactile elements, the magnetic stripe segments facilitate identification of the location of the magnetic stripe segments, as well as identification of the location of an IC chip of the transaction card relative to the location of the magnetic stripe segments. Thus, the magnetic stripe segments facilitate identification of a correct orientation for the transaction card for swiping at a magnetic stripe reader and/or for tapping or inserting at a chip reader. In this way, computing resources, power resources, and/or network resources, that may have otherwise been expended by a magnetic stripe reader and/or a chip reader attempting to process a transaction card in an improper orientation, may be conserved. Moreover, the transaction card may enable faster execution time of transactions, thereby improving an efficiency and a throughput of the magnetic stripe reader and/or the chip reader.

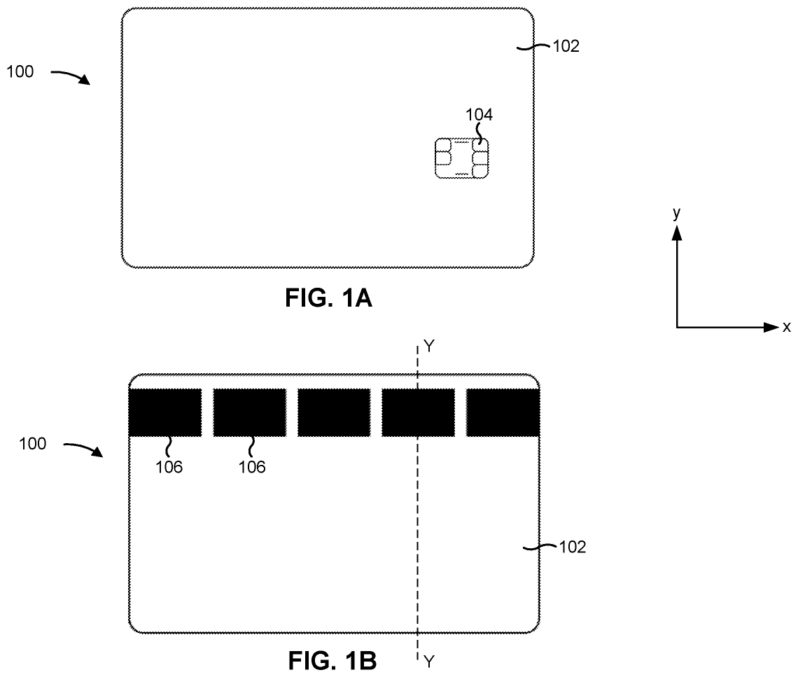

FIGS. 1A-1B show an example transaction card 100. The transaction card 100 may include a credit card, a debit card, a gift card, an ATM card, a rewards card, an access card, or a client loyalty card, among other examples.

The transaction card 100 may include a card body 102. The card body 102 may have a length (e.g., along the x-axis shown) and a height (e.g., along the y-axis shown). In some implementations, the length of the card body 102 may be greater than the height of the card body 102 (e.g., the card body 102 may be in the shape of a rectangle). For example, the length of the card body 102 may be about (e.g., ±5%) 85 millimeters (mm) (e.g., 85.6 mm) and the height of the card body 102 may be about 54 mm (e.g., 53.98 mm). The card body 102 may include (e.g., may be composed of) a resilient material (e.g., a material that returns to an equilibrium position following deformation). For example, the card body 102 may include a plastic (e.g., polyvinyl chloride (PVC)) and/or a metal (e.g., steel). The card body 102 may include a thin substrate, and may have a first surface (e.g., a front surface), as shown in FIG. 1A, and a second surface (e.g., a back surface), as shown in FIG. 1B, opposite the first surface.

In some implementations, the transaction card 100 may include an IC chip 104 (e.g., a EUROPAY®, MASTERCARD®, VISA® (EMV) chip). The IC chip 104 may be embedded in the card body 102 and accessible from the first surface of the card body 102 via a set of electrical contacts. The transaction card 100 may include a plurality of magnetic stripe segments 106 (also referred to as “magnetic strip segments”). The magnetic stripe segments 106 may be non-contiguous with each other, thereby defining gaps (e.g., void spaces) between magnetic stripe segments 106, as shown. A magnetic stripe segment 106 may be truncated in height or in length relative to a conventional magnetic stripe of a transaction card. For example, respective lengths of the magnetic stripe segments 106 (e.g., along the x-axis shown) may be less than the length of the card body 102. In some implementations, a maximum distance (e.g., along the x-axis shown) between consecutive magnetic stripe segments 106 may be less than the respective lengths of the magnetic stripe segments 106.

The magnetic stripe segments 106 may be connected to (e.g., disposed on or embedded in, as described herein) the second surface of the card body 102. In some implementations, the magnetic stripe segments 106 may be connected to the second surface of the card body 102 by an adhesive layer between the magnetic stripe segments 106 and the card body 102 (e.g., the magnetic stripe segments 106 may be stickers). In some implementations, the transaction card 100 may include an overlay layer disposed on the card body 102, and the overlay layer may include the magnetic stripe segments 106. The overlay layer may be affixed to the card body 102 by an adhesive.

The magnetic stripe segments 106 may be connected to the second surface of the card body 102 at a magnetic stripe region of the card body 102 (e.g., a region of the card body 102 that contains the magnetic stripe segments 106). The magnetic stripe region of the card body 102 may be a region that is readably-accessible to a magnetic stripe reader when the transaction card 100 is swiped through the magnetic stripe reader. For example, the magnetic stripe region of the card body 102 may be a region that is conventionally occupied by a conventional magnetic stripe of a transaction card. As an example, the magnetic stripe region may extend a length of the card body 102 (e.g., about 85 mm) and extend from about 10% to about 20%, such as about 15%, of a height of the card body 102 (e.g., about 9 mm). The magnetic stripe segments 106 may be arranged on the card body 102 in a row that extends along the length of the card body 102 (e.g., along the x-axis shown), and the row may run parallel to an edge of the card body 102 (e.g., a top edge or a bottom edge). Here, each magnetic stripe segment 106 may be in a respective column along the row. In other words, the magnetic stripe segments 106 may be arranged in a line.

The magnetic stripe segments 106 may be accessible from the second surface of the card body 102. For example, the magnetic stripe segments 106 may be readable (e.g., by a magnetic stripe reader) from the second surface of the card body 102. The IC chip 104 and the magnetic stripe segments 106 may store and/or encode information associated with the transaction card 100. For example, the information may indicate an account associated with the transaction card 100. In some implementations, the magnetic stripe segments 106 may each encode information indicating a same account associated with the transaction card. For example, the magnetic stripe segments 106 may each encode the same information. In some implementations, the transaction card 100 may include information associated with the account printed, embossed, or the like, on the first surface and/or on the second surface of the card body 102. For example, the information may indicate a name of an account holder of the account, an account identifier (e.g., a credit card number) of the account, a name of an issuer (e.g., a financial institution) of the account, a type of the transaction card 100, an expiration date of the account, and/or a security code for the transaction card 100, among other examples.

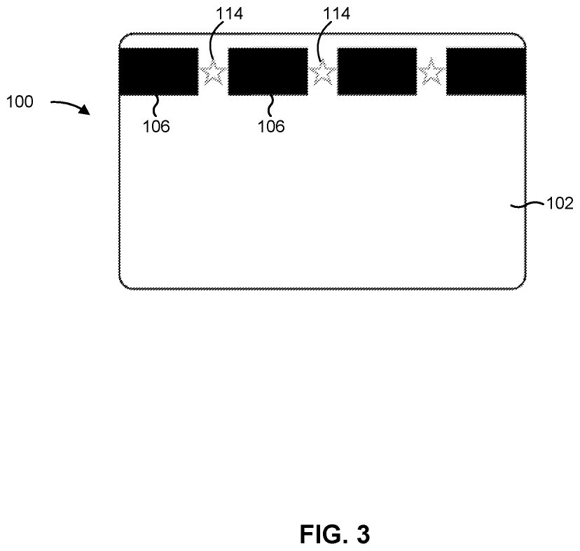

The magnetic stripe segments 106 may function as tactile elements. For example, a configuration of the magnetic stripe segments 106 may define a tactile pattern. As an example, the tactile pattern may be based on sizes, shapes, and locations of the magnetic stripe segments 106 as well as sizes, shapes, and locations of the gaps between the magnetic stripe segments 106. The tactile pattern may indicate an attribute of the transaction card 100. For example, the attribute may be an issuer of the transaction card 100 and/or a type of the transaction card 100. In other words, the tactile pattern defined by the configuration of the magnetic stripe segments 106 may differentiate the transaction card 100 from another transaction card that employs magnetic stripe segments in a different configuration to define a different tactile pattern, such as one of the configurations shown in FIGS. 3-6.

The magnetic stripe segments 106 may be arranged arbitrarily or in a pattern. In some implementations, the magnetic stripe segments 106 may be evenly spaced from each other. In some implementations, the spacing between first adjacent magnetic stripe segments 106 may be different from the spacing between second adjacent magnetic stripe segments 106. In some implementations, the magnetic stripe segments 106 may be uniformly sized and shaped. In other words, each of the magnetic stripe segments 106 may have the same size and shape. In some implementations, a first magnetic stripe segment 106 may have a different size and/or a different shape from a second magnetic stripe segment 106.

By arranging the magnetic stripe segments 106 in the magnetic stripe region of the transaction card 100, the magnetic stripe segments 106 facilitate identification of an orientation of the transaction card 100 and identification of a location of the magnetic stripe segments 106 and/or the IC chip 104 (e.g., relative to the location of the magnetic stripe segments 106). In this way, a correct orientation of the transaction card 100 for use at a magnetic stripe reader or a chip reader may be easily identified.

As indicated above, FIGS. 1A-1B are provided as an example. Other examples may differ from what is described with regard to FIGS. 1A-1B.

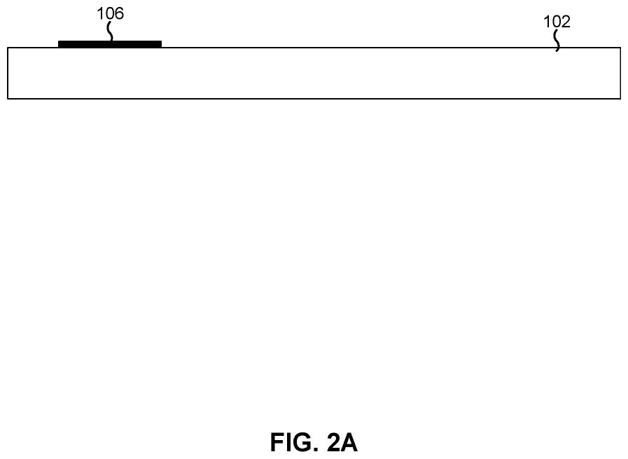

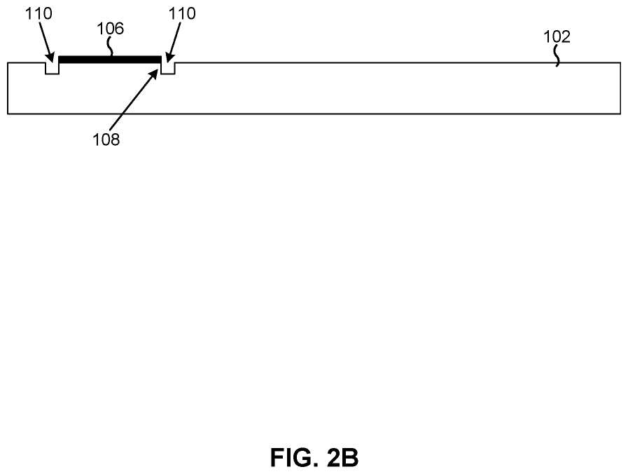

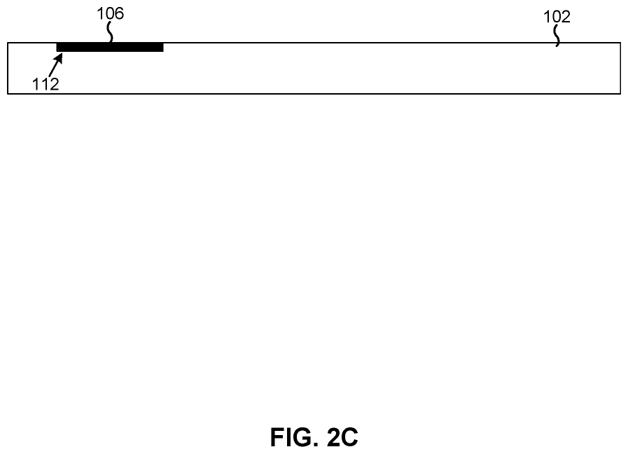

FIG. 2A shows a cross-sectional view of the example transaction card 100 taken along line Y-Y. In some implementations, as shown, a magnetic stripe segment 106 may be raised relative to a surface of the card body 102. For example, each of the magnetic stripe segments 106 may be raised relative to the surface of the card body 102. As another example, one or more magnetic stripe segments 106 may be raised relative to the surface of the card body 102 and one or more magnetic stripe segments 106 may be level with or below the surface of the card body 102. In this way, the magnetic stripe segments 106 may function as tactile elements. In some implementations, the magnetic stripe segments 106 may each be raised the same distance from the surface of the card body 102. In some implementations, a first magnetic stripe segment 106 may be raised a first distance from the surface of the card body 102, and a second magnetic stripe segment 106 may be raised a second distance from the surface of the card body 102 that is different from the first distance.

As indicated above, FIG. 2A is provided as an example. Other examples may differ from what is described with regard to FIG. 2A.

FIG. 2B shows an alternative cross-sectional view of the example transaction card 100 taken along line Y-Y. In some implementations, as shown, a magnetic stripe segment 106 may be raised relative to a surface of the card body 102 and disposed on a mesa 108 of the card body 102, which may be a portion of the card body 102 that is surrounded by a recessed channel 110. For example, each of the magnetic stripe segments 106 may be disposed on respective mesas 108 of the card body 102. As another example, one or more magnetic stripe segments 106 may be disposed on respective mesas 108 of the card body 102 and one or more magnetic stripe segments 106 may not be disposed on mesas. The mesas 108, and associated recessed channels 110, may enhance the tactile properties of the magnetic stripe segments 106.

As indicated above, FIG. 2B is provided as an example. Other examples may differ from what is described with regard to FIG. 2B.

FIG. 2C shows an alternative cross-sectional view of the example transaction card 100 taken along line Y-Y. In some implementations, as shown, a magnetic stripe segment 106 may be disposed in a recess 112 in the card body 102. For example, each of the magnetic stripe segments 106 may be disposed in respective recesses 112 in the card body 102. As another example, one or more magnetic stripe segments 106 may be disposed in respective recesses 112 in the card body 102 and one or more magnetic stripe segments 106 may be disposed on top of the surface of the card body 102. The edges of the recesses 112, as well as the transitions in material from the card body 102 to the magnetic stripe segments 106 disposed in the recesses 112, may provide the tactile properties of the magnetic stripe segments 106.

As indicated above, FIG. 2C is provided as an example. Other examples may differ from what is described with regard to FIG. 2C.

FIG. 3 shows the example transaction card 100 with a plurality of tactile elements 114. A tactile element 114 may be raised or recessed relative to a surface of the card body 102. For example, a tactile element 114 may be raised (e.g., by 1 mm or less) or recessed relative to the surface of the card body 102 on which the magnetic stripe segments 106 are disposed. A tactile element 114 may be located between magnetic stripe segments 106 (e.g., consecutive magnetic stripe segments 106). For example, the tactile elements 114 may be interleaved with the magnetic stripe segments 106. In some implementations, multiple non-contiguous tactile elements 114 may be located between consecutive magnetic stripe segments 106.

In some implementations, the tactile elements 114 may be uniformly sized and shaped. In other words, each of the tactile elements 114 may have the same size and shape. In some implementations, a first tactile element 114 may have a different size and/or a different shape from a second tactile element 114. In some implementations, the tactile elements 114 may each be raised the same distance from the surface of the card body 102. In some implementations, a first tactile element 114 may be raised a first distance from the surface of the card body 102, and a second tactile element 114 may be raised a second distance from the surface of the card body 102 that is different from the first distance.

The tactile elements 114 may include (e.g., may be composed of) a non-ferrous material. In this way, the tactile elements 114 may not interfere with reading of the magnetic stripe segments 106. In some implementations, the tactile elements 114 may include (e.g., may be composed of) dual-state ink that is ultraviolet (UV) light-curable. For example, the ink may be applied to the card body 102 in a liquid state, and the ink may harden to a solid state upon exposure to UV light. In some implementations, the tactile elements 114 may include (e.g., may be composed of) additively-layered material (e.g., a plastic material). For example, the tactile elements 114 may be layered onto the card body 102 using additive printing. In some implementations, the tactile elements 114 may be embossed on the card body 102. In some implementations, the transaction card 100 may include an overlay layer disposed on the magnetic stripe segments 106, and the overlay layer may include the tactile elements 114. The overlay layer may be affixed to the magnetic stripe segments 106 by an adhesive. The tactile elements 114 on the overlay layer may include dual-state ink that is UV-light curable, additively-layered material, or embossing, in a similar manner as described above.

The combination of the magnetic stripe segments 106 and the tactile elements 114 may define a tactile pattern of the transaction card 100, in a similar manner as described above. Thus, the combination of the magnetic stripe segments 106 and the tactile elements 114 may facilitate differentiation of the transaction card 100 from other transaction cards.

As indicated above, FIG. 3 is provided as an example. Other examples may differ from what is described with regard to FIG. 3.

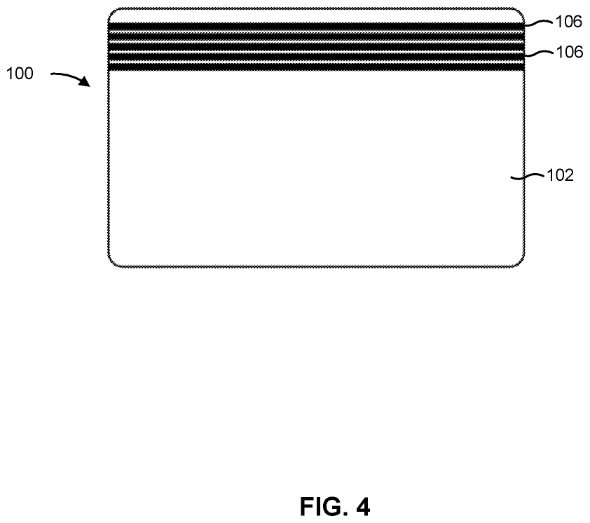

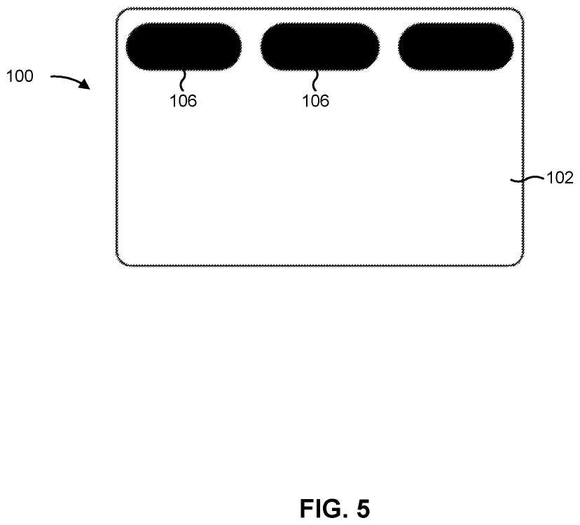

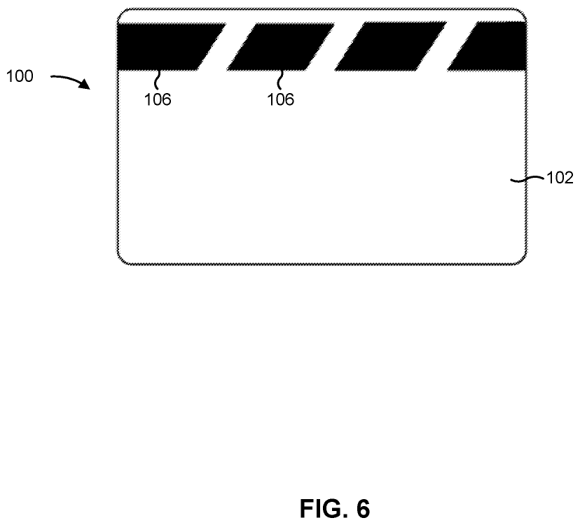

FIGS. 4-6 show the example transaction card 100 with alternative configurations of the magnetic stripe segments 106. As shown in FIG. 4, the magnetic stripe segments 106 may be parallel and extend along the length of the card body 102. For example, the magnetic stripe segments 106 may be arranged on the card body 102 in a column, and each magnetic stripe segment 106 may be in a respective row that extends along the length of the card body 102. The configurations of the magnetic stripe segments 106 of FIGS. 4-6 may define respective tactile patterns that indicate an attribute of a transaction card, as described above. For example, the tactile pattern defined by the configuration of FIG. 4 may indicate a first issuer and/or a first type of transaction card, the tactile pattern defined by the configuration of FIG. 5 may indicate a second issuer and/or a second type of transaction card, and the tactile pattern defined by the configuration of FIG. 6 may indicate a third issuer and/or a third type of transaction card. In this way, the magnetic stripe segments 106 facilitate differentiation between multiple different transaction cards.

As indicated above, FIGS. 4-6 are provided as examples. Other examples may differ from what is described with regard to FIGS. 4-6.

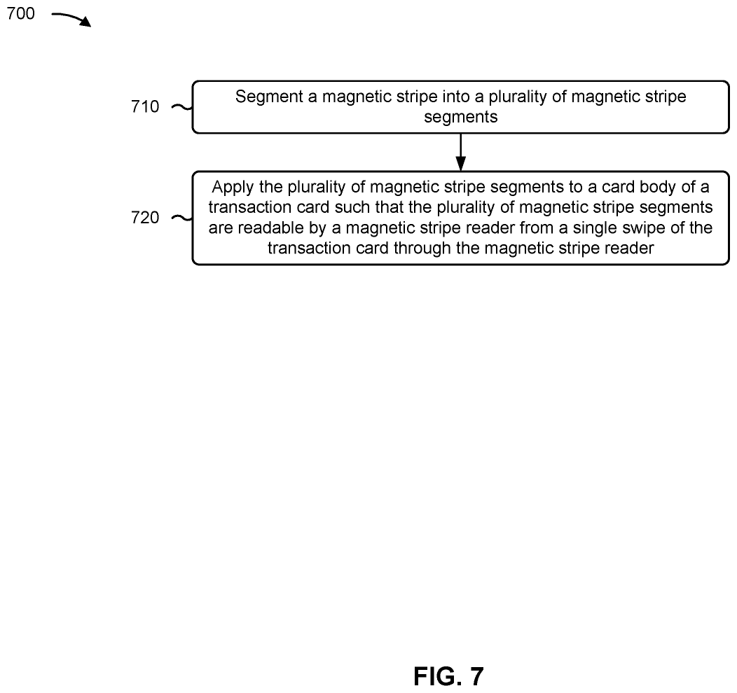

FIG. 7 is a flowchart of an example process 700 associated with manufacturing a transaction card with magnetic stripe segments. In some implementations, one or more process blocks of FIG. 7 may be performed by transaction card manufacturing equipment.

As shown in FIG. 7, process 700 may include segmenting a magnetic stripe into a plurality of magnetic stripe segments (block 710). As further shown in FIG. 7, process 700 may include applying the plurality of magnetic stripe segments to a card body of a transaction card such that the plurality of magnetic stripe segments are readable by a magnetic stripe reader from a single swipe of the transaction card through the magnetic stripe reader (block 720).

In some implementations, applying the plurality of magnetic stripe segments includes applying an overlay layer on the card body, and the overlay layer comprises the plurality of magnetic stripe segments. In some implementations, process 700 may include forming the card body to have a plurality of recesses in the card body, and the plurality of magnetic stripe segments are applied to the card body in respective recesses of the plurality of recesses. In some implementations, process 700 may include forming the card body to have a plurality of mesas in the card body, and the plurality of magnetic stripe segments are applied to the card body on the plurality of mesas. In some implementations, process 700 may include applying one or more tactile elements to the card body of the transaction card between magnetic stripe segments.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transaction card, comprising:
a card body; and
a plurality of magnetic stripe segments disposed on the card body,
wherein the plurality of magnetic stripe segments are non-contiguous with each other,
wherein the plurality of magnetic stripe segments are arranged on the card body such that the plurality of magnetic stripe segments are readable by a magnetic stripe reader from a single swipe of the transaction card through the magnetic stripe reader, and
wherein the plurality of magnetic stripe segments define a tactile pattern that indicates an attribute of the transaction card.

2. The transaction card of claim 1, wherein the attribute of the transaction card is at least one of an issuer of the transaction card or a type of the transaction card.

3. The transaction card of claim 1, wherein the plurality of magnetic stripe segments are arranged on the card body in a row that extends along a length of the card body.

4. The transaction card of claim 3, wherein the row is parallel to an edge of the card body.

5. The transaction card of claim 1, wherein respective lengths of the plurality of magnetic stripe segments are less than a length of the card body.

6. The transaction card of claim 1, wherein the plurality of magnetic stripe segments are parallel and extend along a length of the card body.

7. The transaction card of claim 1, further comprising:
a tactile element located between magnetic stripe segments of the plurality of magnetic stripe segments.

8. The transaction card of claim 1, wherein the plurality of magnetic stripe segments are disposed in respective recesses in the card body.

9. The transaction card of claim 1, wherein the plurality of magnetic stripe segments are disposed on respective mesas of the card body.

10. The transaction card of claim 1, wherein the plurality of magnetic stripe segments each encode information indicating a same account associated with the transaction card.

11. A transaction card, comprising:
a card body; and
a plurality of magnetic stripe segments disposed on the card body,
wherein the plurality of magnetic stripe segments are non-contiguous with each other, and
wherein the plurality of magnetic stripe segments define a tactile pattern that indicates an attribute of the transaction card.

12. The transaction card of claim 11, wherein the attribute of the transaction card is at least one of an issuer of the transaction card or a type of the transaction card.

13. The transaction card of claim 11, wherein the plurality of magnetic stripe segments are arranged on the card body in a row that extends along a length of the card body.

14. The transaction card of claim 11, wherein the plurality of magnetic stripe segments are parallel and extend along a length of the card body.

15. The transaction card of claim 11, wherein the plurality of magnetic stripe segments are disposed in respective recesses in the card body.

16. The transaction card of claim 11, wherein the plurality of magnetic stripe segments are disposed on respective mesas of the card body.

17. A method, comprising:
segmenting a magnetic stripe into a plurality of magnetic stripe segments; and
applying the plurality of magnetic stripe segments to a card body of a transaction card such that the plurality of magnetic stripe segments are readable by a magnetic stripe reader from a single swipe of the transaction card through the magnetic stripe reader.

18. The method of claim 17, wherein applying the plurality of magnetic stripe segments comprises:
applying an overlay layer on the card body,
wherein the overlay layer comprises the plurality of magnetic stripe segments.

19. The method of claim 17, further comprising:
forming the card body to have a plurality of recesses in the card body,
wherein the plurality of magnetic stripe segments are applied to the card body in respective recesses of the plurality of recesses.

20. The method of claim 17, further comprising:
forming the card body to have a plurality of mesas in the card body, wherein the plurality of magnetic stripe segments are applied to the card body on the plurality of mesas.
